(19) United States
(12) Patent Application Publication
(10) Pub. No.: US 2020/0032116 A1
(43) Pub. Date: Jan. 30, 2020

(54) POLARIZING FILM ADHESIVE COMPOSITION, MANUFACTURING METHOD OF POLARIZING FILM ADHESIVE LAYER, POLARIZING FILM WITH ADHESIVE LAYER, AND IMAGE DISPLAY DEVICE

(71) Applicant: NITTO DENKO CORPORATION, Ibaraki-shi, Osaka (JP)

(72) Inventors: Tomoyuki Kimura, Ibaraki-shi (JP); Hirotomo Ono, Ibaraki-shi (JP); Akiko Sugino, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/337,159

(22) PCT Filed: Sep. 27, 2017
(86) PCT No.: PCT/JP2017/034977

§ 371 Date: Mar. 27, 2019

(30) Foreign Application Priority Data
Sep. 30, 2016 (JP) 2016-194931

(51) Int. Cl. C09J 133/08; G02F 1/1335; C09J 11/06

(52) U.S. Cl. CPC C09J 133/08; G02F 2202/28; C09J 11/06; G02F 1/133528

(57) ABSTRACT

The purpose of the present invention is to provide a pressure-sensitive adhesive composition for a polarizing film from which a pressure-sensitive adhesive layer for a polarizing film can be obtained which can suppress separator peeling strength and can specifically suppress increases in separator peeling strength even when stored for a long period of time after production, and further has excellent durability (heat resistance) even when exposed to high temperature heating conditions and heating/humidifying conditions; and to provide a method for a pressure-sensitive adhesive layer for a polarizing film, the pressure-sensitive adhesive layer attached polarizing film polarizing film which includes the pressure-sensitive adhesive layer, and an image display device that includes the pressure-sensitive adhesive layer attached polarizing film. A pressure-sensitive adhesive composition for a polarizing film, which contains an organic tellurium compound, a (meth)acrylic polymer (A), and a compound (B) that generates radicals by heat or active energy rays.

### TECHNICAL FIELD

The present invention relates to a pressure-sensitive adhesive composition for a polarizing film and a method for manufacturing a pressure-sensitive adhesive layer for a polarizing film obtained from the pressure-sensitive adhesive composition for a polarizing film. The present invention also relates to a pressure-sensitive adhesive layer attached polarizing film, which has the pressure-sensitive adhesive layer, and an image display device including the pressure-sensitive adhesive layer attached polarizing film.

### BACKGROUND ART

In a liquid crystal display device or the like, it is indispensable to arrange polarizers (polarizing elements) on both sides of a liquid crystal cell in view of the image forming method, and in general, a polarizing film is attached thereto. In addition to polarizing films, various optical elements for improving the display quality of displays have come into use in liquid crystal panels. For example, a retardation film for preventing coloring, a viewing angle expansion film for improving the viewing angle of the liquid crystal display, and a brightness enhancement film for improving the contrast of display are used. These films are collectively called optical films. In addition, the polarizer is bonded to a protective film or another optical film via an adhesive or a pressure-sensitive adhesive (layer) and is generally used as a laminated film.

In general, a pressure-sensitive adhesive is used to bond an optical member such as the optical film to a liquid crystal cell. In order to reduce optical losses, the optical film and the liquid crystal cell or the optical films are generally bonded together with a pressure sensitive adhesive. In such a case, the pressure-sensitive adhesive is provided in advance as a pressure-sensitive adhesive layer on one side of the optical film, and the resulting pressure-sensitive adhesive layer attached optical film is generally used because it has some advantages such as no need for a drying process to fix the optical film. A separator (release film) is usually attached to the pressure-sensitive adhesive layer of the pressure-sensitive adhesive layer attached optical film.

The required properties required for the pressure-sensitive adhesive layer include high durability under heating/humidification conditions in a state in which the pressure-sensitive adhesive layer is stuck to an optical film and in a state in which the pressure-sensitive adhesive layer attached optical film is bonded to a glass substrate of a liquid crystal panel. For example, in a durability test under heating and humidification conditions etc. commonly conducted as an environment promotion test, high adhesion reliability and the like that no defects such as foaming, peeling, lifting, etc. caused by the pressure-sensitive adhesive layer occur are required.

In addition, an optical film (for example, a polarizing film) tends to shrink due to heat treatment, and there is a problem such that a pressure-sensitive adhesive layer itself is also deformed due to shrinkage of the polarizing film.

In particular, a pressure-sensitive adhesive layer or a pressure-sensitive adhesive layer attached optical films used for outdoor use and used for automotive displays such as car navigation and mobile phones that are supposed to be inside of a high temperature car, are required to have high adhesion reliability and durability at high temperatures.

If peeling strength against a separator (separator peeling strength) is too large, for example, in peeling the separator from the optical film in the step of laminating the optical film to the image display device, malfunctions such that the separator cannot be peeled off or the optical film is detached from the adsorption plate fixing the optical film occur, which may cause a significant reduction in the productivity of the image display panel, which is not preferable.

Particularly in recent years, thinning of the optical film makes it easy for the optical film itself to bend, so that it is difficult to peel off the optical film by following the peeling direction of the separator. Therefore, a pressure-sensitive adhesive (a pressure-sensitive adhesive layer) having smaller peeling strength of the separator than before is required.

Under such circumstances, Patent Document 1 has proposed a pressure-sensitive adhesive composition in which 4 to 20 parts by weight of an isocyanate-based crosslinking agent is blended with 100 parts by weight of an acrylic polymer containing a polar monomer such as an aromatic ring-containing monomer and an amide group-containing monomer.

In addition, Patent Document 2 has proposed a protective film having a pressure-sensitive adhesive layer formed from a pressure-sensitive adhesive composition containing a (meth)acrylic ester copolymer obtained by living radical polymerization, an isocyanate-based crosslinking agent, and an organotin compound, and discloses that heavy peeling occurs when an organic tellurium compound is used as a polymerization initiator and that heavy peeling is suppressed by containing an organotin compound.

### PRIOR ART DOCUMENT

### Patent Document

Patent Document 1: JP-A-2012-158702

Patent Document 2: JP-A-2014-31442

### SUMMARY OF THE INVENTION

### Problems to be Solved by the Invention

However, since the pressure-sensitive adhesive composition of Patent Document 1 has a high blending ratio of a crosslinking agent, peeling tends to occur in the durability test, and in particular, such composition does not satisfy adhesion reliability at high temperature required for in-vehicle application.

Further, as disclosed in Patent Document 2, a pressure-sensitive adhesive containing an organotin compound tends to have low adhesiveness to an optical film, and when such an adhesive is applied to an optical film and subjected to a high-temperature durability test, peeling tends to occur between layers of the optical film and the pressure-sensitive adhesive.

The present invention has been made in view of the above circumstances, and the purpose of the present invention is to provide a pressure-sensitive adhesive composition for a polarizing film, which is excellent in durability (heat resistance) without causing foaming or peeling in an adherend under heating/humidification conditions, from which a pressure-sensitive adhesive layer for a polarizing film excellent in peeling property can be obtained, and which can suppress increases in separator peeling strength even when stored for a long period of time after manufacture or exposed under heating conditions for a long time; and to provide a manufacturing method of a pressure-sensitive adhesive layer for a polarizing film, a pressure-sensitive adhesive layer attached polarizing film, which includes the pressure-sensitive adhesive layer, and an image display device which includes the pressure-sensitive adhesive layer attached polarizing film.

### Means for Solving the Problems

The inventors of the present invention conducted intensive studies to solve the above-mentioned problems, and as a result, found the following pressure-sensitive adhesive composition for a polarizing film and the like. The present invention has been completed based on these findings.

That is, the pressure-sensitive adhesive composition for a polarizing film according to the present invention contains an organic tellurium compound, a (meth)acrylic polymer (A), and a compound (B) that generates radicals by heat or active energy rays.

In the pressure-sensitive adhesive composition for a polarizing film according to the present invention, it is preferable that the organic tellurium compound is a compound represented by the following general formula (1):

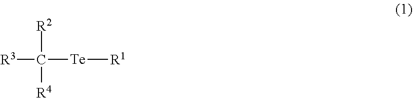

wherein R¹ represents an alkyl group having 1 to 8 carbon atoms, an aryl group, a substituted aryl group or an aromatic heterocyclic group; R² and R³ each represent a hydrogen atom or an alkyl group having 1 to 8 carbon atoms; R⁴ represents an aryl group, a substituted aryl group, an aromatic heterocyclic group, an acyl group, an amide group, an oxycarbonyl group or a cyano group.

In the pressure-sensitive adhesive composition for a polarizing film according to the present invention, it is preferable that the organic tellurium compound further contains a compound represented by the following general formula (2):

R⁵Te₂R⁶ (2)

wherein R⁵ and R⁶ each represent an alkyl group having 1 to 8 carbon atoms, an aryl group, a substituted aryl group or an aromatic heterocyclic group; and R⁵ and R⁶ may be the same as or different from each other.

In the pressure-sensitive adhesive composition for a polarizing film according to the present invention, it is preferable that the compound (B) is a peroxide.

In the pressure-sensitive adhesive composition for a polarizing film according to the present invention, it is preferable that the (meth)acrylic polymer (A) is a polymerized product obtained by using the organic tellurium compound.

In the pressure-sensitive adhesive composition for a polarizing film according to the present invention, it is preferable that the content of the compound (B) is 0.01 to 3 parts by weight per 100 parts by weight of the (meth)acrylic polymer (A).

In the pressure-sensitive adhesive composition for a polarizing film according to the present invention, it is preferable that a polydispersity (weight average molecular weight (Mw)/number average molecular weight (Mn)) of the (meth)acrylic polymer (A) is 3.0 or less.

It is preferable that a method for manufacturing a pressure-sensitive adhesive layer for a polarizing film, comprising the steps of:

preparing the pressure-sensitive adhesive composition for a polarizing film; and

coating the pressure-sensitive adhesive composition for a polarizing film on a support and then subjecting the coated support to a heat treatment or an irradiation treatment with active energy rays to form a pressure-sensitive adhesive layer for a polarizing film.

In the method for manufacturing the pressure-sensitive adhesive layer for a polarizing film according to the present invention, it is preferable to comprise a step of manufacturing the (meth)acrylic polymer (A) by living radical polymerization.

In the method for manufacturing the pressure-sensitive adhesive layer for a polarizing film according to the present invention, it is preferable that the heating temperature in the heat treatment is 100 to 170° C.

The pressure-sensitive adhesive layer attached polarizing film according to the present invention preferably has a polarizing film and a pressure-sensitive adhesive layer that is formed on at least one side of the polarizing film with use of the pressure-sensitive adhesive composition for the polarizing film.

It is preferable that the image display device of the present invention uses at least one of the pressure-sensitive adhesive layer attached polarizing film.

### Effect of the Invention

The pressure-sensitive adhesive composition for a polarizing film according to the present invention contains an organic tellurium compound, a (meth)acrylic polymer (A), and a compound (B) that generates radicals by heat or active energy rays. The pressure-sensitive adhesive layer for a polarizing film formed by using the pressure-sensitive adhesive composition for a polarizing film can suppress separator peeling strength and can particularly suppress an increase in separator peeling strength even when stored for a long period after production. Further, even when exposed under high temperature heating conditions or heating/humidification conditions, the pressure-sensitive adhesive layer for a polarizing film is useful because of its superiority in durability (heat resistance).

### BRIEF DESCRIPTION OF THE DRAWINGS

FIG. 1 is an example of a schematic cross-sectional view of a pressure-sensitive adhesive layer attached polarizing film according to the present invention.

### MODE FOR CARRYING OUT THE INVENTION

### <(Meth)acrylic Polymer (A)>

The pressure-sensitive adhesive composition for a polarizing film (for a polarizing plate) (simply referred to as “a pressure-sensitive adhesive composition” in some cases) according to the present invention is characterized by containing a (meth)acrylic polymer (A). The (meth)acrylic polymer (A) usually contains, as a monomer unit, an alkyl (meth)acrylate as a main component. Incidentally, the (meth) acrylate refers to acrylate and/or methacrylate, and the term “(meth)” is used in the same meaning in the present invention.

As the alkyl (meth)acrylate forming the main skeleton of the (meth)acrylic polymer (A), a linear or branched alkyl group having 1 to 13 carbon atoms can be exemplified. Examples of such alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups, and the like. These can be used alone or in combination. The average number of carbon atoms of these alkyl groups is preferably from 3 to 9.

It is preferable that the (meth)acrylic polymer (A) contains a hydroxyl group-containing monomer as a monomer unit. The hydroxyl group-containing monomer is preferably a compound containing a hydroxyl group in its structure and containing a polymerizable unsaturated double bond such as a (meth)acryloyl group or a vinyl group. Specific examples of the hydroxyl group-containing monomer include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate, and (4-hydroxymethylcyclohexyl)-methylacrylate. Among the hydroxyl group-containing monomers, from the viewpoint of durability, 2-hydroxyethyl (meth)acrylate and 4-hydroxybutyl (meth)acrylate are preferable, and 4-hydroxybutyl (meth)acrylate is particularly preferable.

It is preferable that the (meth)acrylic polymer contains an amide group-containing monomer as a monomer unit. The amide group-containing monomer is preferably a compound having an amide group in its structure and also having a polymerizable unsaturated double bond such as a (meth)acryloyl group and a vinyl group. Specific examples of the amide group-containing monomer include acrylamide monomers such as (meth)acrylamide, N,N-dimethyl (meth)acrylamide, N,N-diethyl (meth)acrylamide, N-isopropyl acrylamide, N-methyl (meth)acrylamide, N-butyl (meth)acrylamide, N-hexyl (meth)acrylamide, N-methylol (meth)acrylamide, N-methylol-N-propane (meth)acrylamide, aminomethyl (meth)acrylamide, aminoethyl (meth)acrylamide, mercaptomethyl (meth)acrylamide, and mercaptoethyl (meth)acrylamide; N-acryloyl heterocyclic monomers such as N-(meth)acryloylmorpholine, N-(meth)acryloylpiperidine, and N-(meth)acryloylpyrrolidine; and N-vinyl group-containing lactam-based monomers such as N-vinylpyrrolidone and N-vinyl-ε-caprolactam. The amide group-containing monomers are preferable in terms of durability, and among the amide group-containing monomers, an N-vinyl group-containing lactam monomer is particularly preferable for satisfying durability.

When the pressure-sensitive adhesive composition contains a crosslinking agent, these copolymerizable monomers can provide reactive points to the crosslinking agent. The hydroxyl group-containing monomer, which is highly reactive with an intermolecular crosslinking agent, is preferably used to improve cohesiveness or heat resistance of the resulting pressure-sensitive adhesive layer. The hydroxyl group-containing monomer is also preferable from the viewpoint of reworkability.

The (meth)acrylic polymer (A) contains a predetermined amount of each monomer as a monomer unit at a weight ratio with respect to all the constituent monomers (100% by weight). The weight ratio of an alkyl (meth)acrylate can be set as the balance of monomers other than the alkyl (meth)acrylate. Specifically, the weight ratio of the alkyl (meth)acrylate is preferably 60% by weight or more, more preferably from 65 to 99.8% by weight, even more preferably from 70 to 99.6% by weight. It is preferable to set the weight ratio of the alkyl (meth)acrylate within the above range in order to secure the adhesive properties.

The weight ratio of the hydroxyl group-containing monomer is preferably from 0.01 to 10% by weight, more preferably from 0.1 to 8% by weight, even more preferably from 0.3 to 6% by weight, particularly preferably from 0.3 to 3.5% by weight, most preferably from 0.3 to 1.5% by weight. When the weight ratio of the hydroxyl group-containing monomer is less than 0.01% by weight, there is a possibility that the pressure-sensitive adhesive layer becomes insufficient in crosslinking and the durability and adhesive properties may not be satisfied, whereas when the weight ratio of the hydroxyl group-containing monomer exceeds 10% by weight, there is a possibility that the durability cannot be satisfied and peeling strength of the separator becomes higher.

The (meth)acrylic polymer (A) does not need to contain any other monomer unit than the monomer units described above. In order to improve adhesive properties and heat resistance, however, one or more copolymerizable monomers having an unsaturated double bond-containing polymerizable functional group, such as a (meth)acryloyl group or a vinyl group, may be introduced into the polymer by copolymerization.

Specific examples of such copolymerizable monomers include those having a benzene ring, such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethylene glycol (meth)acrylate, ethylene oxide modified nonylphenol (meth)acrylate, ethylene oxide modified cresol (meth)acrylate, phenol ethylene oxide modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate; those having a naphthalene ring, such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; those having a biphenyl ring, such as biphenyl (meth)acrylate; aromatic ring-containing (meth)acrylates; and the like.

In addition, the copolymerizable monomers include acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropane sulfonic acid, (meth)acrylamidopropane sulfonic acid, and sulfopropyl (meth)acrylate; phosphate group-containing monomers such as 2-hydroxyethyl acryloyl phosphate; and the like.

Examples of such monomers for modification also include alkylaminoalkyl (meth)acrylates such as aminoethyl (meth)acrylate, N,N-dimethylaminoethyl (meth)acrylate, and tert-butylaminoethyl (meth)acrylate; alkoxyalkyl (meth)acrylates such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate and vinyl propionate; cyanoacrylate monomers such as acrylonitrile and methacrylonitrile; epoxy group-containing (meth)acrylates such as glycidyl (meth)acrylate; glycol (meth)acrylates such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as tetrahydrofurfuryl (meth)acrylate, fluoro (meth)acrylate, silicone (meth)acrylate, and 2-methoxyethyl acrylate. Further, isoprene, butadiene, isobutylene, vinyl ether and the like can be exemplified.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinyibutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

In the case of the aromatic ring-containing monomer, the proportion of the copolymerizable monomer in the (meth)acrylic polymer (A) is preferably in the range of 3 to 25% by weight, more preferably in the range of 8 to 22% by weight, even more preferably in the range of 12 to 18% by weight at a weight ratio with respect to all the constituent monomers (100% by weight) of the (meth)acrylic polymer (A). When the weight ratio of the aromatic ring-containing monomer is within the above range, display unevenness due to light leakage can be sufficiently suppressed, and durability is excellent, which is preferable. When the weight ratio of the aromatic ring-containing monomer exceeds 25% by weight, the display unevenness is not sufficiently suppressed, and the durability is also lowered. For other copolymerizable monomers, it is preferable that the weight ratio is about 0 to 10% by weight, more preferably about 0 to 7% by weight, even more preferably about 0 to 5% by weight.

It is preferable that the (meth)acrylic polymer (A) does not contain a carboxyl group-containing monomer as a monomer unit. When the carboxyl group-containing monomer is contained, durability (for example, metal corrosion resistance) may not be satisfied in some cases, and such a carboxyl group-containing monomer is also undesirable from the viewpoint of reworkability. When the carboxyl group-containing monomer is used, the carboxyl group-containing monomer is preferably a compound containing a carboxyl group in its structure and containing a polymerizable unsaturated double bond such as a (meth)acryloyl group and a vinyl group. Specific examples of such carboxyl group-containing monomer include (meth)acrylic acid, carboxyethyl (meth)acrylate, carboxypentyl (meth)acrylate, itaconic acid, maleic acid, fumaric acid, crotonic acid, and the like. Among the carboxyl group-containing monomers, acrylic acid is preferable from the viewpoints of copolymerizability, cost, and adhesive properties. In addition, if the carboxyl group-containing monomer is used in a small amount, it is possible to suppress an increase in separator peeling strength over time.

The weight average molecular weight (Mw) of the (meth)acrylic polymer (A) is preferably 700,000 to 3,000,000. In consideration of durability, particularly heat resistance, the weight average molecular weight is more preferably 800,000 to 2,500,000, even more preferably 1,000,000 to 2,500,000. When the weight average molecular weight is less than 700,000, the low molecular weight polymer component increases and the crosslinking density of the gel (pressure sensitive adhesive layer) increases, with the result that the pressure sensitive adhesive layer becomes hard and the stress relaxation property is impaired, which is not preferable. On the other hand, when the weight average molecular weight is larger than 3,000,000, viscosity of the polymer increases or gelation occurs during polymerization, which is not preferable.

The polydispersity (weight average molecular weight (Mw)/number average molecular weight (Mn)) of the (meth)acrylic polymer (A) is preferably 3.0 or less, more preferably from 1.05 to 2.5, even more preferably from 1.05 to 2.0. When the polydispersity (Mw/Mn) is more than 2.5, the number of low molecular weight polymers increases and it is necessary to use a large amount of a crosslinking agent in order to increase the gel fraction of the pressure-sensitive adhesive layer. Thereby, an excessive crosslinking agent reacts with the already gelled polymer to increase the crosslinking density of the gel (pressure-sensitive adhesive layer), and accompanying this, the pressure-sensitive adhesive layer becomes hard and the stress relaxation property is impaired, which is not preferable. In addition, when there are many low molecular weight polymers and uncrosslinked polymers or oligomers (sol contents) are increased, it is presumed that breakage of the pressure sensitive adhesive layer in contact with adherends (for example, optical films, glasses, ITO, etc.) occurs under heating conditions, etc. due to uncrosslinked polymer or the like segregated in the vicinity of the layer interface, which may cause peeling of the pressure-sensitive adhesive layer to result in reduction of durability. Thus, it is preferable to adjust the polydispersity (Mw/Mn) to 3.0 or less. The weight average molecular weight and the polydispersity (Mw/Mn) are values calculated from polystyrene equivalent values determined by GPC (gel permeation chromatography).

In the production of the (meth)acrylic polymer (A), known production methods such as solution polymerization, bulk polymerization, emulsion polymerization, various radical polymerization and the like can be appropriately selected. Among them, solution polymerization is advantageous from the viewpoints of convenience and versatility. From the standpoint of convenience and versatility, it is also preferable to produce the (meth)acrylic polymer (A) by living radical polymerization. In addition, the resulting (meth)acrylic polymer (A) may be any of a random copolymer, a block copolymer, a graft copolymer and the like.

In the production of the (meth)acrylic polymer (A), when living radical polymerization is used, generation of a low molecular weight oligomer or a homopolymer can be suppressed as compared with ordinary free radical polymerization, thereby to be able to improve the adhesion reliability, which is a preferred embodiment.

The polymerization initiators, chain transfer agents, emulsifiers and the like used for the radical polymerization are not particularly limited and can be appropriately selected and used. The weight average molecular weight of the (meth)acrylic polymer (A) can be controlled by the amount of the polymerization initiator and the chain transfer agent used, and the reaction conditions, and the amount used thereof is appropriately adjusted according to these types.

### <Polymerization Initiator>

The pressure-sensitive adhesive composition of the present invention is characterized by containing an organic tellurium compound. The organic tellurium compound can be used as a polymerization initiator in the polymerization for obtaining the (meth)acrylic polymer (A), and after fulfilling its role as a polymerization initiator, the organic tellurium compound can be contained in the pressure-sensitive adhesive composition of the present invention together with the (meth)acrylic polymer (A). Use of an organic tellurium compound makes it easier to adjust the polydispersity of the obtained polymer and further contribute to the improvement of durability of the obtained pressure-sensitive adhesive layer. This is preferable.

The organic tellurium compound is preferably a compound represented by the following general formula (1):

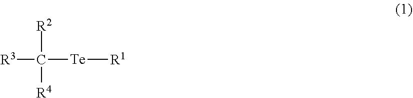

wherein R¹ represents an alkyl group having 1 to 8 carbon atoms, an aryl group, a substituted aryl group or an aromatic heterocyclic group; R² and R³ each represent a hydrogen atom or an alkyl group having 1 to 8 carbon atoms; R⁴ represents an aryl group, a substituted aryl group, an aromatic heterocyclic group, an acyl group, an amide group, an oxycarbonyl group or a cyano group.

Further, as the organic tellurium compound in addition to the compound represented by the general formula (1), it is preferred to further include a compound represented by the following general formula (2):

R⁵Te₂R⁶ (2)

wherein R⁵ and R⁶ each represent an alkyl group having 1 to 8 carbon atoms, an aryl group, a substituted aryl group or an aromatic heterocyclic group, and R⁵ and R⁶ may be the same as or different from each other.

In particular, when preparing the (meth)acrylic polymer (A) by living radical polymerization, examples of usable organic tellurium compounds represented by the general formula (1) include (methyltellanyl-methyl)benzene, (1-methyltellanyl-ethyl)benzene, (2-methyltellanyl-propyl)benzene, 1-chloro-4-(methyltellanyl-methyl)benzene, 1-hydroxy-4-(methyltellanyl-methyl)benzene, 1-methoxy-4-(methyltellanyl-methyl)benzene, 1-amino-4-(methyltellanyl-methyl)benzene, 1-nitro-4-(methyltellanyl-methyl)benzene, 1-cyano-4-(methyltellanyl-methyl)benzene, 1-methylcarbonyl-4-(methyltellanyl-methyl)benzene, 1-phenylcarbonyl-4-(methyltellanyl-methyl)benzene, 1-methoxycarbonyl-4-(methyltellanyl-methyl)benzene, 1-phenoxycarbonyl-4-(methyltellanyl-methyl)benzene, 1-sulfonyl-4-(methyltellanyl-methyl)benzene, 1-trifluoromethyl-4-(methyltellanyl-methyl)benzene, 1-chloro-4-(1-methyltellanyl-ethyl)benzene, 1-hydroxy-4-(1-methyltellanyl-ethyl)benzene, 1-methoxy-4-(1-methyltellanyl-ethyl)benzene, 1-amino-4-(1-methyltellanyl-ethyl)benzene, 1-nitro-4-(1-methyltellanyl-ethyl)benzene, 1-cyano-4-(1-methyltellanyl-ethyl)benzene, 1-methylcarbonyl-4-(1-methyltellanyl-ethyl)benzene, 1-phenylcarbonyl-4-(1-methyltellanyl-ethyl)benzene, 1-methoxycarbonyl-4-(1-methyltellanyl-ethyl)benzene, 1-phenoxycarbonyl-4-(1-methyltellanyl-ethyl)benzene, 1-sulfonyl-4-(1-methyltellanyl-ethyl)benzene, 1-trifluoromethyl-4-(1-methyltellanyl-ethyl)benzene, 1-chloro-4-(2-methyltellanyl-propyl)benzene, 1-hydroxy-4-(2-methyltellanyl-propyl)benzene, 1-methoxy-4-(2-methyltellanyl-propyl)benzene, 1-amino-4-(2-methyltellanyl-propyl)benzene, 1-nitro-4-(2-methyltellanyl-propyl)benzene, 1-cyano-4-(2-methyltellanyl-propyl)benzene, 1-methylcarbonyl-4-(2-methyltellanyl-propyl)benzene, 1-phenylcarbonyl-4-(2-methyltellanyl-propyl)benzene, 1-methoxycarbonyl-4-(2-methyltellanyl-propyl)benzene, 1-phenoxycarbonyl-4-(2-methyltellanyl-propyl)benzene, 1-sulfonyl-4-(2-methyltellanyl-propyl)benzene, 1-trifluoromethyl-4-(2-methyltellanyl-propyl)benzene, 2-(methyltellanyl-methyl)pyridine, 2-(1-methyltellanyl-ethyl)pyridine, 2-(2-methyltellanyl-propyl)pyridine, methyl 2-methyltellanyl-ethanoate, methyl 2-methyltellanyl-propionate, methyl 2-methyltellanyl-2-methylpropionate, ethyl 2-methyltellanyl-ethanoate, ethyl 2-methyltellanyl-propionate, ethyl 2-methyltellanyl-2-methylpropionate, 2-methyltellanyl acetonitrile, 2-methyltellanyl propionitrile, 2-methyl-2-methyltellanyl propionitrile, and the like. The methyltellanyl group in these organic tellurium compounds may be replaced with an ethyltellanyl group, an n-propyltellanyl group, an isopropyltellanyl group, an n-butyltellanyl group, an isobutyltellanyl group, a t-butyltellanyl group, a phenyltellanyl group or the like.

The organic tellurium compounds represented by the general formula (2) include, for example, dimethyl ditelluride, diethyl ditelluride, di-n-propyl ditelluride, diisopropyl ditelluride, dicyclopropyl ditelluride, di-n-butyl ditelluride, di-sec-butyl ditelluride, di-tert-butyl ditelluride, dicyclobutyl ditelluride, diphenyl ditelluride, bis-(p-methoxyphenyl) ditelluride, bis-(p-aminophenyl) ditelluride, bis-(p-nitrophenyl) ditelluride, bis-(p-cyanophenyl) ditelluride, bis-(p-sulfonylphenyl) ditelluride, dinaphthyl ditelluride, dipyridyl ditelluride, and the like. These organic telluride compounds may be used alone, or two or more of them may be used in combination. Among them, dimethyl ditelluride, diethyl ditelluride, di-n-propyl ditelluride, di-n-butyl ditelluride, and diphenyl ditelluride are preferable.

Other polymerization initiators other than the above-mentioned organic tellurium compounds can be used within the range where there is no particular problem in the properties of the pressure-sensitive adhesive composition of the present invention. Other polymerization initiators include azo-based initiators such as 2,2′-azobisisobutylonitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (VA-057, manufactured by Wako Pure Chemical Industries, Ltd.); persulfates such as potassium persulfate and ammonium persulfate; peroxide-based initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

The polymerization initiator may be used alone or as a mixture of two or more kinds thereof, but the content of the polymerization initiator as a whole is preferably about 0.005 to 3 parts by weight, more preferably about 0.02 to 1 part by weight, per 100 parts by weight of the total amount of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, 2,3-dimercapto-1-propanol and the like. The chain transfer agent may be used alone or as a mixture of two or more kinds thereof, but the total content is about 0.1 parts by weight or less per 100 parts by weight of the total amount of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone or in combination of two or more kinds thereof.

Further, as the emulsifier, a reactive emulsifier in which a radically polymerizable functional group such as a propenyl group, an allyl ether group or the like is introduced can be used, and specific examples thereof include AQUALON HS-10, HS-20, KH-10, BC-05, BC-10, and BC-20 (each manufactured by Dai-ichi Kogyo Seiyaku Co., Ltd.) and ADEKARIA SOAP SE10N (manufactured by Asahi Denka Kogyo K.K.). The reactive emulsifier is preferred, because after polymerization, it can be incorporated into a polymer chain to improve water resistance. Based on 100 parts by weight of the total monomer components, the emulsifier is used in an amount of preferably 0.3 to 5 parts by weight, more preferably 0.5 to 1 part by weight, in view of polymerization stability or mechanical stability.

<Compound (B) that Generates Radical by Heat or Active Energy Ray>

The pressure-sensitive adhesive composition of the present invention comprises a compound (B) that generates radicals by heat or active energy rays. The compound (B) is used as a crosslinking agent, and by crosslinking a (meth)acrylic polymer, it is preferable that a moderate cohesive force is given to impart heat resistance and at the same time an increase in separator peeling strength with time can be suppressed. In particular, when a pressure-sensitive adhesive is prepared using a living radical polymer as the (meth)acrylic polymer (A) together with an organic tellurium compound, adhesion between the pressure-sensitive adhesive and the separator increases with time, and it may be difficult to peel off the separator after storage. However, by using the compound (B), it is possible to suppress an increase in separator peeling strength, which is a preferred embodiment. Further, considering adhesive properties, particularly high durability required for in-vehicle applications, it is possible and preferable to suppress peeling in a durability test by using a peroxide or a photopolymerization initiator as the compound (B), and particularly preferred are peroxides.

As the peroxide, any peroxide may be appropriately used as long as it generates active radical species by heat or active energy rays (such as heating or light irradiation) to promote crosslinking of the base polymer ((meth)acrylic polymer (A)) of the pressure-sensitive adhesive composition. However, in view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), 1,1-di(tert-hexylperoxy)cyclohexane (one-minute half-life temperature: 149.2° C.), and mixtures of methyl derivatives of the peroxide, and the like. Among them, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can particularly provide excellent crosslinking reaction efficiency.

The half-life of the peroxide is an indicator of how fast the peroxide can be decomposed and refers to the time required for the amount of the peroxide to reach one half of its original value. The decomposition temperature for obtaining the half-life in arbitrary time and the half-life time at an arbitrary temperature are described in the manufacturer's catalog and the like, for example, in “Organic Peroxide Catalog, 9th Edition (May 2003)” furnished by NOF CORPORATION. As a method for measuring the amount of decomposed peroxide remaining after the reaction treatment, such a decomposed peroxide can be measured by, for example, HPLC (high performance liquid chromatography).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

Examples of the photopolymerization initiator usable as the compound (B) include a benzophenone-based photopolymerization initiator, a ketal-based photopolymerization initiator, an acetophenone-based photopolymerization initiator, a benzoin ether-based photopolymerization initiator, and the like.

Specific examples of the benzophenone-based photopolymerization initiator include benzophenone, benzoylbenzoic acid, 3,3′-dimethyl-4-methoxybenzophenone, polyvinylbenzophenone, α-hydroxycyclohexyl phenyl ketone and the like.

Specific examples of the ketal-based photopolymerization initiator include 2,2-dimethoxy-1,2-diphenylethan-1-one [for example, trade name “IRGACURE 651” (product of Ciba Japan)].

Specific examples of the acetophenone-based photopolymerization initiator include 1-hydroxycyclohexyl phenyl ketone [for example, trade name “IRGACURE 184” (product of Ciba Japan)], 2,2-diethoxyacetophenone, 2,2-dimethoxy-2-phenylacetophenone, 4-phenoxydichloroacetophenone, 4-(t-butyl) dichloroacetophenone, and the like.

Specific examples of the benzoin ether-based photopolymerization initiator include benzoin methyl ether, benzoin ethyl ether, benzoin propyl ether, benzoin isopropyl ether, benzoin isobutyl ether, and the like.

The compound (B) may be used singly or as a mixture of two or more kinds thereof, but the total content is such that the content of the compound (B) is preferably 0.01 to 3 parts by weight, more preferably 0.02 to 2 parts by weight, even more preferably 0.03 to 1 part by weight, per 100 parts by weight of the (meth)acrylic polymer (A). The content of the compound (B) is appropriately selected within the above range in order to control an increase in separator peeling strength over time, crosslinking stability, peelability, and the like. When the content of the compound (B) is too small, suppression of increase in separator peeling strength is insufficient, and when the content of the compound (B) is too much, the pressure-sensitive adhesive layer becomes hard. As a result, the peeling strength (adhesive strength) of the pressure-sensitive adhesive layer decreases and the durability of the pressure-sensitive adhesive layer itself tends to be inferior, which is not preferable.

### <Crosslinking Agent>

In addition to the compound (B), the pressure-sensitive adhesive composition may further contain other crosslinking agents. As such a crosslinking agent, an organic crosslinking agent or a polyfunctional metal chelate (a metal chelate crosslinking agent) can be used. Examples of the organic crosslinking agent include an isocyanate-based crosslinking agent, an epoxy-based crosslinking agent, an imine-based crosslinking agent, a carbodiimide-based crosslinking agent and the like. The polyfunctional metal chelate is one in which a polyvalent metal is covalently or coordinately bonded to an organic compound. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom, and examples of the organic compound include an alkyl ester, an alcohol compound, a carboxylic acid compound, an ether compound, a ketone compound, and the like. Among these, as the crosslinking agent, an isocyanate-based crosslinking agent can be preferably used and in particular, high-molecular-weight (meth)acrylic polymer can be prepared by using an isocyanate-based crosslinking agent in combination with a peroxide as the compound (B) to obtain a pressure-sensitive adhesive layer excellent in stress relaxation property. Compared with the pressure-sensitive adhesive layer using only the isocyanate-based crosslinking agent to be usually used, it is possible and preferable to suppress an initial separator peeling strength and separator peeling strength with time.

The isocyanate-based crosslinking agent may be a compound having at least two isocyanate groups. For example, an aliphatic polyisocyanate, an alicyclic polyisocyanate, or an aromatic polyisocyanate known in the art and commonly used for urethane-forming reaction may be used as the isocyanate-based crosslinking agent.

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, 2,4,4-trimethylhexamethylene diisocyanate, and the like.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, hydrogenated tetramethylxylylene diisocyanate, and the like.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate, and the like.

Examples of the isocyanate-based crosslinking agent include multimers (such as dimers, trimers, or pentamers) of these diisocyanates, and urethane-modified products formed by the reaction with a polyalcohol such as trimethylolpropane, urea-modified products, biuret-modified products, allophanate-modified products, isocyanurate-modified products, carbodiimide-modified products, and the like.

Commercially available examples of the isocyanate-based crosslinking agent include “MILLIONATE MT”, “MILLIONATE MTL”, “MILLIONATE MR-200”, “MILLIONATE MR-400”, “CORONATE L”, “CORONATE HL”, and “CORONATE HX” (all trade names, manufactured by NIPPON POLYURETHANE INDUSTRY CO., LTD.), and “TAKENATE D-110N”, “TAKENATE D-120N”, “TAKENATE D-140N”, “TAKENATE D-160N”, “TAKENATE D-165N”, “TAKENATE D-170HN”, “TAKENATE D-178N”, “TAKENATE 500”, and “TAKENATE 600” (all trade names, manufactured by Mitsui Chemicals, Inc.). These compounds may be used alone or in combination of two or more kinds thereof.

As the isocyanate-based crosslinking agent, preferred are an aliphatic polyisocyanate and an aliphatic polyisocyanate-based compound that is a modified product thereof. Aliphatic polyisocyanate-based compounds can form a crosslinked structure more flexible than that obtained with other isocyanate crosslinking agents, can easily relax the stress associated with the expansion/shrinkage of optical films, and are less likely to cause peeling in a durability test. In particular, preferred aliphatic polyisocyanate-based compounds include hexamethylene diisocyanate and derivatives thereof.

The amount of the crosslinking agent to be used is preferably 0.01 to 3 parts by weight, more preferably 0.02 to 2 parts by weight, particularly preferably 0.05 to 1 part by weight, per 100 parts by weight of the (meth)acrylic polymer (A). If the amount of the crosslinking agent, is less than 0.01 parts by weight, the pressure-sensitive adhesive layer becomes insufficient in crosslinking and there is a possibility that the durability and the adhesive properties may not be satisfied, whereas if the amount of the crosslinking agent exceeds 3 parts by weight, the pressure-sensitive adhesive layer tends to be too hard and the durability tends to decrease.

The pressure-sensitive adhesive composition of the present invention may contain a silane coupling agent. By using the silane coupling agent, the durability can be improved. Specific examples of the silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane. Epoxy group-containing silane coupling agents are preferred among the silane coupling agents listed above.

As the silane coupling agent, one having a plurality of alkoxysilyl groups in the molecule can also be used. Specific examples thereof include X-41-1053, X-41-1059A, X-41-1056, X-41-1805, X-41-1818, X-41-1810, and X-40-2651 manufactured by Shin-Etsu Chemical Co., Ltd. These silane coupling agents having a plurality of alkoxysilyl groups in the molecule are preferable in that they are less volatile and effective in improving durability due to their two or more alkoxysilyl groups. In particular, these silane coupling agents can provide suitable durability also when the adherend on the pressure-sensitive adhesive layer attached optical film is a transparent conductive layer (such as an ITO), which is less reactive with the alkoxysilyl group than glass. The silane coupling agent having a plurality of alkoxysilyl groups in the molecule is preferably one having an epoxy group in the molecule, more preferably one having two or more epoxy groups in the molecule. The silane coupling agent having a plurality of alkoxysilyl groups and an epoxy group(s) in the molecule tends to provide good durability also when the adherend is a transparent conductive layer (such as an ITO). Specific examples of the silane coupling agent having a plurality of alkoxysilyl groups and an epoxy group(s) in the molecule include X-41-1053, X-41-1059A, and X-41-1056 manufactured by Shin-Etsu Chemical Co., Ltd, among which X-41-1056 manufactured by Shin-Etsu Chemical Co., Ltd. is particularly preferred, which has a high epoxy group content.

The silane coupling agents may be used alone, or a mixture of two or more thereof. The total amount of the silane coupling agent is preferably from 0.001 to 5 parts by weight, more preferably from 0.01 to 1 part by weight, even more preferably from 0.02 to 1 part by weight, particularly preferably from 0.05 to 0.6 parts by weight, per 100 parts by weight of the (meth)acrylic polymer. If the content of the silane coupling agent is within the above range, durability is improved and a suitable level of adhering strength to glass and transparent conductive layers is maintained.

The pressure-sensitive adhesive composition may also contain any other known additive within a range not impairing the properties. For example, an antistatic agent (an ionic compound such as an ionic liquid and an alkali metal salt), a colorant, a powder such as a pigment, a dye, a surfactant, a plasticizer, a tackifier, a surface lubricant, a leveling agent, a softening agent, an antioxidant, an anti-aging agent, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range. These additives are preferably used in an amount of 5 parts by weight or less, more preferably 3 parts by weight or less, even more preferably 1 part by weight or less, per 100 parts by weight of the (meth)acrylic polymer (A).

### <Pressure-Sensitive Adhesive Layer>

The method for manufacturing the pressure-sensitive adhesive layer for a polarizing film (which may be simply referred to as “a pressure-sensitive adhesive layer” in some cases) according to the present invention includes a step of preparing the pressure-sensitive adhesive composition for a polarizing film, and a step of applying the pressure-sensitive adhesive composition for a polarizing film onto a support, followed by a heat treatment or an irradiation treatment with active energy rays, thereby to form a pressure-sensitive adhesive layer for a polarizing film.

The pressure-sensitive adhesive composition forms a pressure-sensitive adhesive layer, but in forming the pressure-sensitive adhesive layer, it is preferable to sufficiently consider the influence of the crosslinking treatment temperature and the crosslinking treatment time as well as to adjust the amount of the entire crosslinking agent used.

Depending on the crosslinking agent to be used, the crosslinking treatment temperature and the crosslinking treatment time can be adjusted.

The crosslinking treatment temperature is preferably 170° C. or less. In particular, when forming a pressure-sensitive adhesive layer by heat treatment, the crosslinking treatment temperature (heating temperature in the heat treatment) is more preferably in the range of 100 to 170° C., even more preferably in the range of 120 to 170° C., particularly preferably in the range of 130 to 160° C. The above temperature range is preferable because a pressure-sensitive adhesive layer can be obtained while suppressing decomposition of the polymer. If the heating temperature is too high, curling generated in the optical film (e.g. polarizing film) to be attached is increased due to thermal shrinkage of the support (separator), and this is not preferable.

The crosslinking treatment may be carried out at the temperature at the time of the drying step of the pressure-sensitive adhesive layer or may be carried out by providing a separate crosslinking treatment step after the drying step.

Examples of the active energy ray include ionizing radiation such as alpha rays, beta rays, gamma rays, neutron rays, and election rays, ultraviolet rays, and the like, and ultraviolet rays are particularly preferable. Further, as the device (active energy ray irradiation device) for applying the active energy ray is not particularly limited and conventional active energy ray irradiation devices can be used. For example, ultraviolet ray generating lamp (UV lamp), EB (electron beam) irradiating device and the like can be mentioned. As the UV lamp, for example, high-pressure discharge lamps such as a metal halide lamp and a high-pressure mercury lamp, and low-pressure discharge lamps such as a chemical lamp, a black light lamp and an insect-trap fluorescent lamp are preferable.

Regarding the crosslinking treatment time (heating time or irradiation time of active energy), such a treatment time can be set in consideration of productivity and workability but is usually about 0.2 to 20 minutes, preferably about 0.5 to 10 minutes.

### <Pressure-Sensitive Adhesive Layer Attached Polarizing Film>

In the present invention, as the pressure-sensitive adhesive layer attached polarizing film, it is preferable that the pressure-sensitive adhesive layer is formed on at least one side of the polarizing film. Further, the pressure-sensitive adhesive layer can be used not only as the polarizing film but also as being attached to an optical film. As the optical film, in addition to a polarizing film (polarizing plate) containing the polarizer, a retardation film, an optical compensation film, a brightness enhancement film, and those laminated via an adhesive or a pressure-sensitive adhesive layer can be used. In the present invention, the polarizer refers to a laminated film which is bonded to a protective film or another optical film with an adhesive or a pressure-sensitive adhesive (layer) interposed therebetween, and the pressure-sensitive adhesive composition (pressure-sensitive adhesive) and the pressure-sensitive adhesive layer used in the laminated film including the polarizer are referred to as a pressure-sensitive adhesive composition for a polarizing film and a pressure-sensitive adhesive layer for a polarizing film.

As a method for forming a pressure-sensitive adhesive layer, there is exemplified a method in which the pressure-sensitive adhesive composition may be applied to a support (for example, a separator subjected to release treatment, and the like), and a polymerization solvent or the like is removed by drying to form a pressure-sensitive adhesive layer, which is then transferred to an optical film (for example, a polarizing film), or a method in which the pressure-sensitive adhesive composition is applied to an optical film and the polymerization solvent or the like is removed by drying to form a pressure-sensitive adhesive layer on the optical film. In applying the pressure-sensitive adhesive composition, one or more kinds of solvents other than the polymerization solvent may be newly added as needed.

### <Support (Separator)>

A silicone release liner is preferably used as the support (for example, a separator subjected to release treatment). In the step of applying and drying the pressure-sensitive adhesive composition of the present invention on such a liner to form a pressure-sensitive adhesive layer, an appropriate method is suitably adopted as a method of drying the pressure-sensitive adhesive according to the purpose.

Further, the pressure-sensitive adhesive layer can be formed after forming an anchor layer on the surface of the optical film or subjecting the optical film to various easy adhesion treatments such as corona treatment and plasma treatment. In addition, easy adhesion treatment may be performed on the surface of the pressure-sensitive adhesive layer.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, extrusion coating with a die coater, and the like.

The thickness of the pressure-sensitive adhesive layer is not particularly limited but is, for example, about 1 to 100 μm, preferably 2 to 50 μm, more preferably 2 to 40 μm, even more preferably 5 to 35 μm.

When the pressure-sensitive adhesive layer is exposed, the pressure-sensitive adhesive layer may be protected with a sheet having undergone release treatment (a separator) before practical use.

Examples of the constituent material of the support (separator) include plastic films such as polyethylene, polypropylene, polyethylene terephthalate, and polyester film; porous materials such as paper, cloth, and nonwoven fabric; and appropriate thin sheets such as net, foamed sheet, metal foil, and laminate thereof. From the viewpoint of excellent surface smoothness, a plastic film is suitably used.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film, and the like.

The thickness of the support (separator) is generally set to about 5 to 200 μm, preferably about 5 to 100 μm. If necessary, on the support, the separator may be subjected to release and antifouling treatments using a silicone-based, fluoride-based, long-chain alkyl-based or fatty acid amide-based release agent, a silica powder or the like, or may be subjected to an antistatic treatment using an antistatic agent such as an application type, a kneading type, a vapor deposition type or the like. Particularly, a surface of the separator may be appropriately subjected to a release treatment such as a silicone treatment, a long-chain alkyl treatment or a fluorine treatment, to further enhance peelability of the separator from the pressure-sensitive adhesive layer.

The release-treated sheet used for preparing the pressure-sensitive adhesive layer attached polarizing film (further, a pressure-sensitive adhesive layer attached optical film including other optical films in addition to the polarizing film) can be directly used as a separator of the pressure-sensitive adhesive layer attached polarizing film, and this makes it possible to simplify the process aspect.

### <Image Display Device>

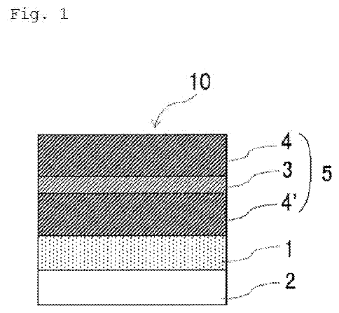

Further, in the present invention, it is preferable to form an image display device using at least one pressure-sensitive adhesive layer attached polarizing film. As the polarizing film, a polarizing film used for forming an image display device such as a liquid crystal display device is used, and its kind is not particularly limited. For example, in addition to a polarizing film (polarizing plate) including a polarizer and a polarizing film, a film containing other optical films can be mentioned as the polarizing film. The polarizing film includes a polarizer, and ones having a transparent protective film on one side or both sides of the polarizer can be used (see, for example, FIG. 1).

The polarizer is not particularly limited but various kinds of polarizer may be used. Examples of the polarizer, include a film obtained by uniaxial stretching after a dichromatic substance, such as iodine and dichromatic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a film polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable. Thickness of these polarizers is not particularly limited but is generally about 80 μm or less.

A polarizer that is uniaxially stretched after a polyvinyl alcohol-based film dyed with iodine is obtained by stretching a polyvinyl alcohol-based film by 3 to 7 times the original length, after dipped and dyed in an aqueous solution of iodine. If necessary, the polyvinyl alcohol-based film can be immersed in an aqueous solution of potassium iodide or the like which may contain boric acid, zinc sulfate, zinc chloride or the like. Further, if necessary, the polyvinyl alcohol-based film before dyeing may be immersed in water and washed with water. By rinsing polyvinyl alcohol-based film with water, it is possible to clean contamination on the surface of the polyvinyl alcohol-based film and anti-blocking agent, and in addition, the effect of preventing unevenness such as unevenness of dyeing can be exhibited by allowing the polyvinyl alcohol-based film to be swollen. The stretching may be applied after dyeing with iodine or may be applied concurrently, or conversely dyeing with iodine may be applied after stretching. Stretching is applicable in an aqueous solution of boric acid and potassium iodide, or in water bath.

The thickness of the polarizer is preferably 30 μm or less. From the viewpoint of thinning, the thickness is more preferably 25 μm or less, even more preferably 20 μm or less, particularly preferably 15 μm or less. Such a thin type polarizer has less thickness unevenness, excellent visibility and less dimensional change, so that the polarizer is excellent in durability even under heating/humidification conditions, and foaming and peeling hardly occur. Furthermore, it is preferable that the thickness of the polarizing film can be reduced.

Typical examples of such a thin polarizer include the thin polarizers disclosed in JP-A-51-069644, JP-A-2000-338325, WO 2010/100917, specification of PCT/JP2010/001460, specification of Japanese Patent Application No. 2010-269002, or specification of Japanese Patent Application No. 2010-263692. These thin polarizers can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

The thin polarizer should be produced by a process capable of achieving high-ratio stretching to improve polarizing performance, among processes including the steps of stretching and dyeing a laminate. From this point of view, the thin polarizer is preferably obtained by a process including the step of stretching in an aqueous boric acid solution as described in WO 2010/100917 A, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as described in Japanese Patent Application No. 2010-269002 or 2010-263692.

A thermoplastic resin with a high level of transparency, mechanical strength, thermal stability, moisture blocking properties, isotropy, and the like may be used as a material for forming a transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin resins (norbornene-based resins), polyarylate resins, polystyrene resins, polyvinyl alcohol resins, and a mixture thereof. The transparent protective film may be bonded with an adhesive layer to one side of the polarizer. On the other side of the polarizer, a thermosetting or ultraviolet-curable resin such as a (meth)acrylic, urethane, acrylic urethane, epoxy, and silicone resin may be used to form the transparent protective film. The transparent protective film may contain any one or more suitable additives. Such additives include, for example, ultraviolet absorbers, antioxidants, lubricants, plasticizers, release agents, anti-coloring agents, flame retardants, nucleating agents, antistatic agents, pigments, and colorants. The content of the thermoplastic resin in the transparent protective film is preferably from 50 to 100% by weight, more preferably from 50 to 99% by weight, even more preferably from 60 to 98% by weight, particularly preferably from 70 to 97% by weight. If the content of the thermoplastic resin in the transparent protective film is 50% by weight or less, high transparency and other properties inherent in the thermoplastic resin may be insufficiently exhibited.

The adhesive used to bond the polarizer to the transparent protective film may be any of various optically-transparent adhesives, such as aqueous adhesives, solvent type adhesives, hot melt type adhesives, radical-curable type adhesives, and cationically curable type adhesives, among which aqueous adhesives or radical-curable type adhesives are preferred.

Examples of the optical film include a film serving as an optical layer for use in forming a liquid crystal display device or the like, such as a reflective plate, an anti-transmission plate, a retardation plate (including a wavelength plate such as a ½ or ¼ wavelength plate), a visual compensation film, or a brightness enhancement film. In addition to being used as an optical film together with a polarizer, these can be used in the form of one layer or two or more layers by laminating on the polarizing film with the pressure-sensitive adhesive layer etc. in practical use.

The optical film including a laminate of the polarizing film and the optical layer may be formed by a method of laminating them one by one in the process of manufacturing a liquid crystal display device or the like. However, an optical film formed in advance by lamination is advantageous in that it can facilitate the process of manufacturing a liquid crystal display device or the like because it has stable quality and good assembling workability. In the lamination, any appropriate bonding means such as a pressure-sensitive adhesive layer may be used. When the polarizing film and any other optical layer are bonded together, their optical axes may be each aligned at an appropriate angle, depending on the desired retardation properties or other desired properties.

The pressure-sensitive adhesive layer attached polarizing film (further, a pressure-sensitive adhesive layer attached optical film including other optical film in addition to the polarizing film) according to the present invention is preferably used for forming liquid crystal display devices or other various image display devices. Liquid crystal display devices may be formed according to conventional techniques. Specifically, a liquid crystal display device may be typically formed by appropriately assembling a display panel such as a liquid crystal cell, a pressure-sensitive adhesive layer attached polarizing film, and an optional component such as a lighting system, and incorporating a driving circuit according to any conventional techniques. In the present invention, there is no particular limitation except that the pressure-sensitive adhesive layer attached polarizing film according to the present invention is used, and the present invention is performed according to conventional methods. The liquid crystal cell to be used may also be of any type such as TN type, STN type, π type, VA type, or IPS type.

Suitable liquid crystal display devices, such as a liquid crystal display device in which a pressure-sensitive adhesive layer attached polarizing film (further, a pressure-sensitive adhesive layer attached optical film including other optical films in addition to the polarizing film) is disposed on one side or both sides of a display panel such as a liquid crystal cell, and a liquid crystal display device using a backlight or a reflective plate as a lighting system can be formed. In this case, the pressure-sensitive adhesive layer attached polarizing film according to the present invention can be disposed on one side or both sides of a display panel such as a liquid crystal cell. When optical films (for example, polarizing films) are provided on both sides, they may be of the same type or of different type. Further, in forming the liquid crystal display device, appropriate components such as a diffusion layer, an antiglare layer, an antireflection film, a protective plate, a prism array, a lens array sheet, an optical diffusion sheet, a backlight, may be disposed in suitable position in one layer or two or more layers.

### EXAMPLES

The present invention is specifically described by Examples below, which are not intended to limit the scope of the present invention. In each Example, parts and percentages are all on a weight basis. Unless otherwise stated below, the conditions of room temperature standing are 23° C. and 65% RH in all the cases.

### <Measurement of Weight Average Molecular Weight (Mw) of (Meth)acrylic Polymer (A)>

The weight average molecular weight (Mw) of the (meth)acrylic polymer (A) was measured by GPC (gel permeation chromatography). The polydispersity (Mw/Mn) of the (meth)acrylic polymer (A) was also determined using the same method.

Analyzer: HLC-8120 GPC, manufactured by TOSOH CORPORATION

Columns: G7000 H_{XL}+GM H_{XL}+GM H_{XL}, manufactured by TOSOH CORPORATION

Column size: each 7.8 mmφ×30 cm, 90 cm in total

Column temperature: 40° C.

Flow rate: 0.8 ml/minute

Injection volume: 100 μl

Eluent: 10 mM phosphoric acid/tetrahydrofuran

Detector: differential refractometer (RI)

Standard sample: polystyrene

### <Preparation of Polarizing Film (Polarizing Plate)>

An 80-μm-thick polyvinyl alcohol film was stretched to 3 times between rolls different in velocity ratio while the film was dyed in a 0.3% iodine solution at 30° C. for 1 minute. The film was then stretched to a total stretch ratio of 6 times while the film was immersed in an aqueous solution containing 4% of boric acid and 10% of potassium iodide at 60° C. for 0.5 minutes. Subsequently, the film was washed by immersion in an aqueous solution containing 1.5% of potassium iodide at 30° C. for 10 seconds and then dried at 50° C. for 4 minutes to give a 28-μm-thick polarizer. A polarizing film (a polarizing plate) was formed by bonding an 80-μm-thick saponified triacetylcellulose (TAC) films to both sides of the polarizer with a polyvinyl alcohol-based adhesive.

### Example 1

### (Preparation of (Meth)acrylic Polymer (A1): Living Radical Polymerization)

In a glove box substituted with argon, 0.035 parts of ethyl 2-methyl-2-n-butyltellanyl-propionate, 0.0025 parts of 2,2′-azobisisobutyronitrile, and 1 part of ethyl acetate were placed into a reaction vessel. Then, the reaction vessel was sealed and taken out from the glove box.

Subsequently, 95 parts of butyl acrylate, 5 parts of 4-hydroxybutyl acrylate and 50 parts of ethyl acetate as a polymerization solvent were charged into the reaction vessel while argon gas was flowing into the reaction vessel, and a polymerization reaction was carried out for 20 hours while keeping the liquid temperature in the reaction vessel at about 60° C. to prepare a solution of a (meth)acrylic polymer (A1) having a weight average molecular weight (Mw) of 1,800,000 and a Mw/Mn ratio of 2.00.

### (Preparation of Pressure-Sensitive Adhesive Composition)

A solution of an acrylic pressure-sensitive adhesive composition was prepared by blending 0.1 parts of a peroxide-based crosslinking agent (NYPER BMT, benzoyl peroxide, manufactured by NOF Corporation) corresponding to the compound (B), 0.3 parts of an isocyanate-based cross-linking agent (TAKENATE D-160N, trimethylolpropane hezamethylene diisocyanate, manufactured by Mitsui Chemicals, Inc.), and 0.2 parts of a silane coupling agent (X-41-1810, manufactured by Shin-Etsu Chemical Co., Ltd.), with respect to 100 parts of the solid content of the solution of the (meth)acrylic polymer (A1) obtained above.

### (Production of Pressure-Sensitive Adhesive Layer Attached Polarizing Film)

Next, the solution of the acrylic pressure-sensitive adhesive composition was coated on one side of a polyethylene terephthalate film (separator film: MRF 38, thickness 38 μm, manufactured by Mitsubishi Polyester Film Corporation) treated with a silicone-based peeling agent in such a manner that the thickness of the pressure-sensitive adhesive layer after drying became 20 μm, and then dried at 155° C. for 1 minute to form a pressure-sensitive adhesive layer on the surface of the separator film. Subsequently, the pressure-sensitive adhesive layer formed on the separator film was transferred to the produced polarizing film to prepare a pressure-sensitive adhesive layer attached polarizing film in a state where a separator film was attached.

### (Preparation of (Meth)acrylic Polymer (A2): Living Radical Polymerization)

In a glove box substituted with argon, 0.07 parts of ethyl 2-methyl-2-n-butyltellanyl-propionate, 0.005 parts of 2,2′-azobisisobutyronitrile, and 1 part of ethyl acetate were placed into a reaction vessel. Then, the reaction vessel was sealed and taken out from the glove box.

Subsequently, 95 parts of butyl acrylate, 5 parts of 4-hydroxybutyl acrylate, and 50 parts of ethyl acetate as a polymerization solvent were charged into the reaction vessel while argon gas was flowing into the reaction vessel, and polymerization reaction was carried out for 20 hours while keeping the liquid temperature in the reaction vessel at about 60° C. to prepare a solution of a (meth)acrylic polymer (A2) having a weight average molecular weight (Mw) of 840,000 and a Mw/Mn ratio of 1.60.

### (Preparation of (Meth)acrylic Polymer (A3): Living Radical Polymerization)

In a glove box substituted with argon, 0.035 parts of ethyl 2-methyl-2-n-butyltellanyl-propionate, 0.0025 parts of 2,2′-azobisisobutyronitrile, and 1 part of ethyl acetate were placed into a reaction vessel. Then, the reaction vessel was sealed and taken out from the glove box.

Subsequently, 99 parts of butyl acrylate, 1 part of 4-hydroxybutyl acrylate, and 50 parts of ethyl acetate as a polymerization solvent were charged into the reaction vessel while argon gas was flowing into the reaction vessel, and polymerization reaction was carried out for 20 hours while keeping the liquid temperature in the reaction vessel at about 60° C. to prepare a solution of a (meth)acrylic polymer (A3) having a weight, average molecular weight (Mw) of 1,300,000 and a Mw/Mn ratio of 1.75.

### (Preparation of (Meth)acrylic Polymer (A4))

A monomer mixture containing 99 parts of butyl acrylate and 1 part of 4-hydroxybutyl acrylate was charged into a four-necked flask equipped with a stirring blade, a thermometer, a nitrogen gas inlet tube and a condenser. Further, 0.1 parts of 2,2′-azobisisobutyronitrile as a polymerization initiator was added to 100 parts of the monomer mixture (solid content) together with 85 parts of ethyl acetate and 15 parts of toluene, and nitrogen gas was introduced thereto to perform nitrogen substitution in the reaction vessel with gentle stirring. Then, polymerization reaction was carried out for 6 hours while keeping the liquid temperature in the flask at around 55° C. to prepare a solution of a (meth)acrylic polymer (A4) having a weight average molecular weight (Mw) of 1,790,000 and a Mw/Mn ratio of 4.15.

### (Preparation of (Meth)acrylic Polymer (A5): Living Radical Polymerization)

In a glove box substituted with argon, 0.035 parts of ethyl 2-methyl-2-n-butyltellanyl-propionate, 0.0025 parts of 2,2′-azobisisobutyronitrile, and 1 part of ethyl acetate were placed into a reaction vessel. Then, the reaction vessel was sealed and taken out from the glove box.

Subsequently, 81 parts of butyl acrylate, 16 parts of phenoxyethyl acrylate, 3 parts of 4-hydroxybutyl acrylate, and 50 parts of ethyl acetate as a polymerization solvent were charged into the reaction vessel while argon gas was flowing into the reaction vessel. Then, polymerization reaction was carried out for 20 hours while keeping the liquid temperature in the reaction vessel at about 60° C. to prepare a solution of a (meth)acrylic polymer (A5) having a weight average molecular weight (Mw) of 1,370,000 and a Mw/Mn ratio of 2.12.

### (Preparation of (Meth)acrylic Polymer (A6): Living Radical Polymerization)

In a glove box substituted with argon, 0.035 parts of ethyl 2-methyl-2-n-butyltellanyl-propionate, 0.0025 parts of 2,2′-azobisisobutyronitrile, and 1 part of ethyl acetate were placed into a reaction vessel. Then, the reaction vessel was sealed and taken out from the glove box.

Subsequently, 76 parts of butyl acrylate, 16 parts of phenoxyethyl acrylate, 7 parts of N-vinyl pyrrolidone, 1 part of 4-hydroxybutyl acrylate, and 50 parts of ethyl acetate as a polymerization solvent were charged into the reaction vessel while introducing argon gas into the reaction vessel. Then, polymerization reaction was carried out for 20 hours while keeping the liquid temperature in the reaction vessel at about 60° C. to prepare a solution of a (meth)acrylic polymer (A6) having a weight average molecular weight (Mw) of 1,240,000 and a Mw/Mn ratio of 1.74.

### Examples 2 to 5, 7 to 8 and Comparative Examples 1 to 2

In Examples 2 to 5, 7 to 8 and Comparative Examples 1 to 2, a (meth)acrylic polymer (A) having polymer physical properties shown in Table 1 and an acrylic pressure-sensitive adhesive composition solution were prepared as in Example 1, except that the type and amount of the monomer, the compound (B), etc., and the presence or absence of use were changed as shown in Table 1. Using the acrylic pressure-sensitive adhesive composition solution, a pressure-sensitive adhesive layer attached polarizing film in a state where a separator film was attached was prepared in the same manner as in Example 1.

### Example 6

### (Preparation of Pressure-Sensitive Adhesive Composition)

A solution of an acrylic pressure-sensitive adhesive composition was prepared by blending 0.04 parts of a benzophenone-based crosslinking agent (benzophenone, manufactured by Wako Pure Chemical Industries, Ltd.) corresponding to the compound (B), 0.1 parts of an isocyanate-based crosslinking agent (TAKENATE D-160N, trimethylolpropane hexamethylene diisocyanate, manufactured by Mitsui Chemicals, Inc.), and 0.2 parts of a silane coupling agent (X-41-1810, manufactured by Shin-Etsu Chemical Co., Ltd.) with respect to 100 parts of the solid content of the solution of the (meth)acrylic polymer (A1).

### (Production of Pressure-Sensitive Adhesive Layer Attached Polarizing Film)

Next, the solution of the acrylic pressure-sensitive adhesive composition was coated on one side of a polyethylene terephthalate film (separator film: MRF 38, thickness 38 μm, manufactured by Mitsubishi Polyester Film Corporation) treated with a silicone-based peeling agent in such a manner that the thickness of the pressure-sensitive adhesive layer after drying became 20 μm, and then dried at 90° C. for 1 minute to form a pressure-sensitive adhesive layer on the surface of the separator film. Thereafter, using a high-pressure mercury lamp, such adhesive layer was irradiated with ultraviolet rays having an integrated light amount of 300 mJ/cm². Subsequently, the pressure-sensitive adhesive layer formed on the separator film was transferred to the produced polarizing film to prepare a pressure-sensitive adhesive layer attached polarizing film in a state where a separator film was attached.

Using the pressure-sensitive adhesive layer attached polarizing film obtained in the above Examples and Comparative Examples in which a separator film was attached, the following evaluations were carried out. The evaluation results are shown in Table 2.

### <Measurement of Separator Peeling Strengths>

A sheet piece having a length of 100 mm and a width of 50 mm was cut out from the pressure-sensitive adhesive layer attached polarizing film in a state where a separator film was attached to the prepared pressure-sensitive adhesive layer surface. Then, the sheet piece was allowed to stand in an atmosphere of 23° C. and 50% RH for 1 hour and was used as a sample.

Using a tensile tester (apparatus name “Autograph AG-IS”, manufactured by Shimadzu Corporation), under the conditions of 23° C. and 50% RH, a tensile rate of 300 mm/min, and a peel angle of 180°, the separator film was peeled off and the 180° peeling adhering strength (N/50 mm) was measured. Then, this 180° peeling adhesion strength was defined as initial separator peeling strength (N/50 mm).

The pressure-sensitive adhesive layer attached polarizing film was allowed to stand still at 60° C. for 500 hours, and then 180° peeling adhesion strength (N/50 mm) was measured under an atmosphere of 23° C. and 50% RH as with the measurement of the initial separator peeling strength. Then, this 180° peeling adhesion strength was defined as separator peeling strength (N/50 mm) after the heating process.

The separator peeling strength is preferably 2 N/50 mm or less, more preferably 0.01 to 1 N/50 mm, even more preferably 0.05 to 0.5 N/50 mm, particularly preferably 0.05 to 0.2 N/50 mm, most preferably 0.05 to 0.15 N/50 mm, either in the initial stage or after the heating process. When the separator peeling strength is within the above range, peeling defects do not occur in the separating operation of the separator, and this is preferable.

### <Durability Test on ITO Glass>

A pressure-sensitive adhesive layer attached polarizing film cut into a size of 37 inches was used as a sample. An amorphous ITO layer was formed on an alkali-free glass (EG-XG, manufactured by Corning Incorporated) having a thickness of 0.7 mm and used as an adherend. The sample of the polarizing film with a pressure-sensitive adhesive layer was laminated to the surface of the amorphous ITO layer using a laminator. Then, the laminate was autoclaved at 50° C. and 0.5 MPa for 15 minutes to completely adhere the sample to the adherend. The sample subjected to such treatment was treated for 500 hours under each atmosphere of 95° C. (high temperature heating) and 65° C./95% RH (heating/humidification), and then the appearance between the polarizing film and the amorphous ITO layer was visually observed according to the following criteria, thereby to evaluate the durability against the ITO glass. The ITO layer was formed by sputtering. The composition of ITO was an Sn ratio of 3% by weight, and a heating step of 140° C.×60 minutes was carried out before bonding the samples, respectively. The Sn content of ITO was calculated from weight of Sn atoms/(weight of Sn atoms+weight of In atoms).

### (Evaluation Criteria)

⊙: In the sample, there is no change at all in appearance such as foaming, peeling or the like.
∘o: Slight peeling or foaming occurs at the end portion of the sample, but there is no problem in practical use.
Δ: Peeling or foaming occurs at the end portion of the sample, but there is no problem in practical use except for special applications.
×: Significant peeling occurs at the end portion of the sample, causing problems in practical use.

TABLE 1

| | | Composition of | | | | Physical properties | | | | | | Silane |
|---|---|---|---|---|---|---|---|---|---|---|---|---|
| | (Meth) acrylic | polymer (A) | | | | of polymer (A) | | | Compound (B) | | | coupling |
| | polymer (A) | BA | PEA | NVP | HBA | Mw | | Mw/Mn | Kind | Parts | Isocyanate | agent |
| Example 1 | (A1) | 95 | | | 5 | 1.8 | million | 2.00 | Nyper BMT | 0.1 | 0.3 | 0.2 |
| Example 2 | (A1) | 95 | | | 5 | 1.8 | million | 2.00 | Nyper BMT | 0.3 | | 0.2 |
| Example 3 | (A1) | 95 | | | 5 | 1.8 | million | 2.00 | Nyper BMT | 0.3 | 0.1 | 0.2 |
| Example 4 | (A2) | 95 | | | 5 | 0.84 | million | 1.60 | Nyper BMT | 0.3 | 0.1 | 0.2 |
| Example5 | (A3) | 99 | | | 1 | 1.3 | million | 1.75 | Nyper BMT | 0.3 | 0.1 | 0.2 |
| Example 6 | (A1) | 95 | | | 5 | 1.8 | million | 2.00 | Benzophenone | 0.04 | 0.1 | 0.2 |
| Example 7 | (A5) | 81 | 16 | | 3 | 1.37 | million | 2.12 | Nyper BMT | 0.3 | 0.1 | 0.2 |
| Example 8 | (A6) | 76 | 16 | 7 | 1 | 1.24 | million | 1.74 | Nyper BMT | 0.3 | 0.2 | 0.2 |
| Comparative Example 1 | (A1) | 95 | | | 5 | 1.8 | million | 2.00 | | | 0.1 | 0.2 |
| Comparative Example 2 | (A4) | 99 | | | 1 | 1.79 | million | 4.15 | Nyper BMT | 0.3 | 0.1 | 0.2 |

Abbreviations and the like in Table 1 are described below.

BA: Butyl acrylate

HBA: 4-Hydroxybutyl acrylate

PEA: Phenoxyethyl acrylate

NVP: N-vinylpyrroiidone

Isocyanate: TAKENATE D-160N (a hezamethylene diisocyanate adduct of trimethylolpropane, a crosslinking agent) manufactured by Mitsui Chemicals, Inc.

NYPER BMT: NYPER BMT (a mixture of dibenzoyl peroxide and its methyl derivative, compound (B)) manufactured by NOF Corporation

Benzophenone: manufactured by Wako Pure Chemical Industries, Ltd. (Compound (B))

Silane coupling agent: X-41-1810 (a thiol group-containing silicate oligomer) manufactured by Shin-Etsu Chemical Co., Ltd.

TABLE 2

| | Separator peeling | | | |
|---|---|---|---|---|
| | strength | | Durability | |
| | [N/50 mm] | | | 65° C. |
| | Initial | 60° C. | 95° C. | 95% RH |
| | stage | 500 h | 500 h | 500 h |
| Example 1 | 0.17 | 0.20 | Δ | ◯ |
| Example 2 | 0.19 | 0.27 | ◯ | ⊙ |
| Example 3 | 0.26 | 0.31 | ⊙ | ⊙ |
| Example 4 | 0.18 | 0.24 | Δ | ⊙ |
| Example 5 | 0.12 | 0.18 | ◯ | ◯ |
| Example 6 | 0.04 | 0.11 | ◯ | ◯ |
| Example 7 | 0.15 | 0.19 | ⊙ | ⊙ |
| Example 8 | 0.12 | 0.13 | ⊙ | ⊙ |
| Comparative Example 1 | 0.27 | 10.12 | X | ◯ |
| Comparative Example 2 | 0.12 | 0.20 | X | ◯ |

From the evaluation results of Table 2, it was confirmed in Examples that by using the compound (B) which generates radicals by heat or active energy rays, an increase in separator peeling strength with lapse of time in addition to the separator peeling strength at an initial stage can be suppressed. It was also confirmed in Examples that durability (heat resistance) at a practically acceptable level is obtained even under a high temperature heating condition and under heating/humidifying conditions for a long time. On the other hand, in Comparative Example 1, when the compound (B) was not used and only the isocyanate-based crosslinking agent was used as the crosslinking agent, the separator peeling strength greatly increased when exposed under heating conditions for a long time. Furthermore, it was confirmed that when the pressure-sensitive adhesive layer attached polarizing film was exposed to high temperature heating conditions for a long time, durability (heat resistance) of the film was inferior. In Comparative Example 2, since the polymer was prepared by ordinary radical polymerization without using the organic tellurium compound, the polydispersity (Mw/Mn) of the polymer became larger and the durability under heating conditions was confirmed to be poor.

### DESCRIPTION OF REFERENCE SIGNS

1 Pressure-sensitive adhesive layer

2 Separator

3 Polarizer

4, 4′ Protective film

5 Polarizing film (polarizing plate)

10 Pressure-sensitive adhesive layer attached polarizing film

1. A pressure-sensitive adhesive composition for a polarizing film, comprising an organic tellurium compound, a (meth)acrylic polymer (A), and a compound (B) that generates radicals by heat or active energy rays,

2. The pressure-sensitive adhesive composition for a polarizing film according to claim 1, wherein the organic tellurium compound is a compound represented by the following general formula (1): 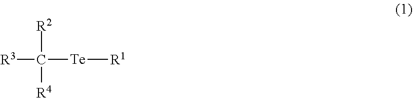
wherein R¹ represents an alkyl group having 1 to 8 carbon atoms, an aryl group, a substituted aryl group or an aromatic heterocyclic group; R² and R³ each represent a hydrogen atom or an alkyl group having 1 to 8 carbon atoms; R⁴ represents an aryl group, a substituted aryl group, an aromatic heterocyclic group, an acyl group, an amide group, an oxycarbonyl group or a cyano group.

3. The pressure-sensitive adhesive composition for a polarizing film according to claim 2, wherein the organic tellurium compound further contains a compound represented by the following general formula (2):
R⁵Te₂R⁶ (2)
wherein R⁵ and R⁶ each represent an alkyl group having 1 to 8 carbon atoms, an aryl group, a substituted aryl group or an aromatic heterocyclic group; and R⁵ and R⁶ are the same as or different from each other.

4. The pressure-sensitive adhesive composition for a polarizing film according to claim 1, wherein the compound (B) is a peroxide.

5. The pressure-sensitive adhesive composition for a polarizing film according to claim 1, wherein the (meth)acrylic polymer (A) is a polymerized product obtained by using the organic tellurium compound.

6. The pressure-sensitive adhesive composition for a polarizing film according to claim 1, wherein the content of the compound (B) is 0.01 to 3 parts by weight per 100 parts by weight of the (meth)acrylic polymer (A).

7. The pressure-sensitive adhesive composition for a polarizing film according to claim 1, wherein a polydispersity (weight average molecular weight (Mw)/number average molecular weight (Mn)) of the (meth)acrylic polymer (A) is 3.0 or less.

8. A method for manufacturing a pressure-sensitive adhesive layer for a polarizing film, comprising the steps of:
preparing the pressure-sensitive adhesive composition for a polarizing film according to claim 1; and
coating the pressure-sensitive adhesive composition for a polarizing film on a support and then subjecting the coated support to a heat treatment or an irradiation treatment with active energy rays to form a pressure-sensitive adhesive layer for a polarizing film.

9. The method for manufacturing a pressure-sensitive adhesive layer for a polarizing film according to claim 8, further comprising a step of manufacturing the (meth)acrylic polymer (A) by living radical polymerization.

10. The method for manufacturing, a pressure-sensitive adhesive layer for a polarizing film according to claim 8, wherein the heating temperature in the heat treatment is 100 to 170° C.

11. A pressure-sensitive adhesive layer attached polarizing film, comprising a polarizing film and a pressure-sensitive adhesive layer formed from the pressure-sensitive adhesive composition for a polarizing fit according to claim 1 on at least one side of the polarizing film.

12. An image display device using at least, one of the pressure-sensitive adhesive layer attached polarizing film according to claim 11.
